(19) United States
(12) Patent Application Publication
(10) Pub. No.: US 2018/0290621 A1
(43) Pub. Date: Oct. 11, 2018

(54) ADJUSTING CARGO TRANSPORTATION UNIT ELEMENTS IN RESPONSE TO THEFT EVENTS

(71) Applicant: BlackBerry Limited, Waterloo (CA)

(72) Inventors: Conrad Delbert Seaman, Ottawa (CA); Stephen West, Manotick (CA); Aaron Lalvani, Milton (CA)

(21) Appl. No.: 15/484,900

(22) Filed: Apr. 11, 2017

(51) Int. Cl. B60R 25/01; B60R 25/08; B60R 25/104; B60R 25/102; B60R 25/33; G06Q 10/08

(52) U.S. Cl. CPC B60R 25/018; B60R 25/08; G06Q 10/0833; B60R 25/102; B60R 25/33; B60R 25/104

(57) ABSTRACT

In some examples, a controller determines a location of a cargo transportation unit (CTU), and responsive to the determined location matching a specified criterion, determines whether a sensor monitored event indicates a theft event associated with the CTU. In response to the theft event, the controller causes adjustment of an adjustable element of the CTU.

### BACKGROUND

Trucks, tractor-trailers, or tractors that are connected to chassis for carrying containers can be used to transport cargo that includes goods. Cargo can be transported from an origin (such as a factory, a warehouse, a retail outlet, etc.) to a destination (such as retail outlet, a warehouse, customer premises, etc.) along a route. Theft is a widespread problem with trailers or other cargo transportation units. Loss of cargo due to theft can be costly to shippers as well customers.

### BRIEF DESCRIPTION OF THE DRAWINGS

Some implementations of the present disclosure are described with respect to the following figures.

FIG. 1 is a block diagram of an example arrangement including a cargo transportation unit (CTU) and a vehicle attached to the CTU, according to some implementations.

FIG. 2 is a flow diagram of an example process of a controller, according to some implementations.

FIG. 3 is a block diagram of a controller according to some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A cargo transportation unit (CTU) in the form of a moveable platform can be used to carry cargo items between different geographic locations. A “cargo item” can refer to any physical item that is to be delivered from one location to another location. “Cargo” can refer to one or more cargo items. In some examples, a CTU can be a container (that is attached to a tractor), a cargo carrying portion of a truck, or a trailer, where the container provides an enclosed space in which the physical items can be stored during shipment. In other examples, the CTU can include another type of carrier structure that is able to carry cargo items. More generally, the CTU can be part of, mounted on, or attached, as applicable, to a vehicle, such as a truck, a trailer, a tractor, a car, a railed vehicle (e.g., a train), a watercraft (e.g., a ship), an aircraft, a spacecraft, and so forth. The vehicle can haul the CTU that is part of, mounted on, or attached to the vehicle.

In some examples, a vehicle to which a CTU is attached to, mounted on, or part of, can be a driverless vehicle that can be self-driving. A driverless vehicle (also referred to as an “autonomous vehicle”) refers to a vehicle that is without a driver, i.e., a human that controls the movement of the vehicle while the driver is located on the vehicle. A self-driving or autonomous vehicle has the intelligence and self-awareness to perform driving tasks, including driving itself from an origin to a destination, without any human driver on the vehicle.

Although reference is made to using driverless vehicles to haul CTUs in some examples, it is noted that in other examples, CTUs can be hauled by vehicles driven by human drivers.

Theft of cargo carried by a CTU can occur in various scenarios. For example, a CTU may be stopped at a particular location for a short duration, such as when a human driver is resting (in examples where a vehicle is driven by a human driver) or the CTU is parked to make a scheduled stop (such as to deliver cargo). During such stops, CTU may be an easy target for theft. In other examples, theft of a CTU may occur at a shipping origin, such as while the CTU filled with cargo is waiting to be picked up by a vehicle. Similarly, theft of a CTU can occur at a shipping destination, after the CTU has been dropped off. CTUs are also frequently used as cheap, expandable, movable storage, and this places goods in storage in such CTUs at risk of theft. Insurance rates for protecting cargo in transit can be very high.

A thief may steal the CTU, such as by disconnecting the CTU from the vehicle hauling the CTU and connecting the CTU to the thief's vehicle. Alternatively, the thief can steal the combination of the vehicle and the CTU (by breaking into the vehicle and driving the vehicle with the CTU away). In further examples, the CTU may not be connected to the vehicle (e.g., the CTU is waiting to be picked up or has been dropped off at a destination)—in such a scenario, a thief can drive the thief's vehicle up to the CTU, connect the thief's vehicle to the CTU, and haul the CTU away.

In other examples, a thief can break into a CTU that is parked to remove cargo from the CTU. Alternatively, a thief can force a vehicle hauling the CTU to stop, such that the thief can break into the CTU to steal the cargo.

In accordance with some implementations of the present disclosure, solutions are provided to cause the CTU to take an action in response to detecting a theft event, where the action taken can be an evasive action (to deter movement of the CTU by making it more difficult for a thief to move the CTU) and/or a protective action (such as to provide a notification of the theft). In some implementations, in response to detecting the theft event, adjustment of an adjustable element of the CTU can be performed to perform the evasive action and/or the protective action. In other examples, the protective action takes the form of instant alerts/alarms designed to notify key stakeholders and reduce the critical time between a theft event and the implementation of response measures.

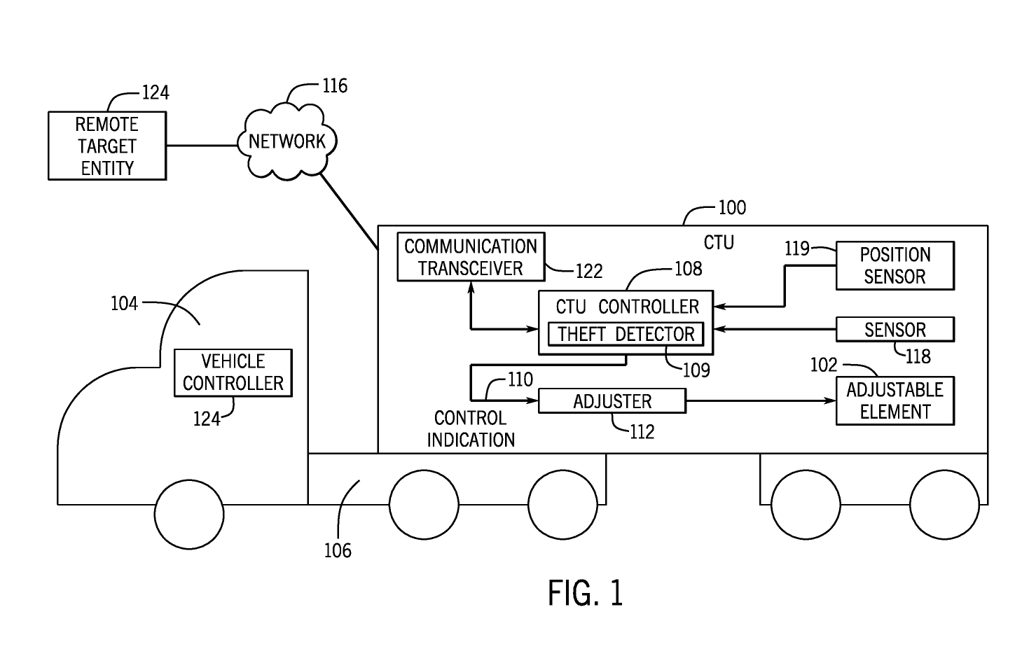

FIG. 1 is a block diagram of an example arrangement that includes a CTU 100 and a vehicle 104 that hauls the CTU 100. As shown in FIG. 1, the CTU 100 is towed by the vehicle 104 (such as a tractor or other type of vehicle). In examples according to FIG. 1, the CTU 100 is separate from the vehicle 104, and the CTU 100 can be attached to a tow platform 106 of the vehicle 104 to allow the vehicle 104 to tow the CTU 100. In other examples, the vehicle 104 can be a truck, and the CTU 100 can be part of the truck 104. In further examples, the vehicle 104 can have a bed or other support structure on which the CTU 100 is placed.

In some examples, the vehicle 104 is a driverless (autonomous) vehicle. In alternative examples, the vehicle 104 can be driven by a human driver.

The CTU 100 includes a CTU controller 108 that includes a theft detector 109 that is able to detect a theft event with respect to the CTU 100. The CTU controller 108 can include a hardware processing circuit that can include any one or more of the following: a microprocessor, a core of a multi-core microprocessor, a microcontroller, a programmable gate array, a programmable integrated circuit device, or another type of hardware processing circuit. In further examples, the CTU controller 108 can include a combination of a hardware processing circuit and machine-readable instructions (software or firmware) executable on the hardware processing circuit.

The theft detector 106 can be a part of the hardware processing circuit of the CTU controller 108, or alternatively, the theft detector 109 can include machine-readable instructions executable on the CTU controller 108.

The CTU controller 108 receives the output of a sensor 118 in the CTU 100. Based on the output of the sensor 118, the theft detector 109 is able to detect a theft event. Although just one sensor 118 is shown in FIG. 1, it is noted that in other examples, there can be multiple sensors that can be used to provide information used by the theft detector 109 to detect a theft event. Generally, as discussed herein, detecting a theft event based on an output of a sensor can refer detecting the theft event based on the output of a single sensor, or based on outputs of multiple sensors.

The CTU 100 also includes a position sensor 119 that is able to make measurements that are useable for determining a position of the CTU 100. The output of the position sensor 119 is provided to the CTU controller 108. Examples of the position sensor 119 include a global positioning system (GPS) receiver, which is able to acquire measurements from satellites and to provide position information (including latitude and longitude) to the CTU controller 108. In other examples, the position sensor 119 can measure signals transmitted by fixed-position wireless transmitters (whose locations are known), such as base stations of a cellular access network or access points of a wireless local area network (WLAN). Using triangulation, the position sensor 119 can use such transmitted signals to determine the position of the CTU 100. In other examples, the position sensor 119 can include another type of sensor used for determining position.

The theft detector 109 receives information from the position sensor 119, and uses such information to determine a location of the CTU 100. In response to the determined location of the CTU 100 matching a specified criterion, the theft detector 109 uses information from the sensor 118 to determine whether a sensor monitored event (an event that is monitored based on using information from the sensor 118) indicates a theft event associated with the CTU 100. For example, as further discussed below, a geofence can define a high-crime area. If the CTU 100 enters the high-crime area, then that is an indication that the determined location of the CTU 100 matches the specified criterion, and thus should trigger the use of the sensor data to determine whether a theft event has occurred. More examples are described below.

In response to the theft event, the CTU controller 108 can cause adjustment of an adjustable element 102 of the CTU 100. The adjustable element 102 can be an adjustable mechanical element, or alternatively, the adjustable element 102 can be an electronic component whose setting can be adjusted.

In some examples, the adjustment of the adjustable element 102 can be performed in the absence of any human driver at the vehicle 104. In other examples, the automated adjustment of the adjustable element 102 can be performed when the vehicle 104 is driven by a human driver.

In FIG. 1, the CTU controller 108 provides a control indication 110 to an adjuster 112, which can perform adjustment of the adjustable element 102 in response to the control indication 110. The control indication 110 can be provided in response to detecting a theft event. The control indication 110 can include a control signal, a control message, an information element in a message, and so forth. In further examples, instead of being part of the CTU 100, the CTU controller 108 can be part of the vehicle 104, and can communicate with the CTU 100.

Adjustment of the adjustable element 102 can include one or more of changing pressure of a tire of the CTU 100 (such as to deflate the tire so that the CTU 100 cannot move easily), locking a brake of the CTU 100 (such that the brake is applied and the CTU 100 cannot move), locking a cargo compartment of the CTU 100 (so that a cargo item cannot be removed from the cargo compartment), sounding an alarm of the CTU 100, triggering transmission of a theft notification, flashing a light of the CTU or the vehicle, disabling an attachment mechanism of the CTU 100 (such that the CTU 100 cannot be detached from the vehicle 104, or alternatively, the disabled attachment mechanism prevents the CTU 100 from being attached to another vehicle), sending a notification message to the vehicle to cause an action at the vehicle (examples provided further below), and so forth.

In some examples, if the adjustable element 102 is a tire, the adjuster 112 can include a gas pump that is able to inflate or deflate the pressure of the tire, by respectively injecting gas into the tire or removing gas from the tire.

If the adjustable element 102 is a brake, then the adjuster 112 can adjust the amount of force being applied by the brake. For example, if the CTU 100 has multiple brakes, then the CTU controller 108 can control the adjuster 112 to control the braking forces applied by the individual brakes.

If the adjustable element 102 is a lock of a compartment, then the adjuster 112 can include a moveable member to lock or unlock the lock. If the adjustable mechanical element 102 is a door of the CTU 100, then the adjuster 112 includes a moveable member to open or close the door.

Other types of adjusters can be used to adjust other adjustable elements.

In further examples, the theft detector 109 can send an indication of a theft event to the vehicle 104, to cause the vehicle 104 to take an evasive action or a protective action. An action taken by the vehicle 104 can include the vehicle 104 locking its brake, deflating its tire, disabling its engine, disabling its transmission, sounding its alarm, flashing its light, and so forth. In an autonomous vehicle scenario, the action taken by the vehicle 104 may involve re-routing the vehicle 104 or actively trying to move the vehicle 104 to a high visibility area while the event is in progress.

A sensor monitored event that can provide an indication of a theft event can include any or some combination of the following:
detecting opening of a barrier (e.g., a door or a window or compartment) of the CTU 100 being opened;
detecting removal of cargo from the CTU 100;
detecting tipping of the CTU 100 being tipped;
detecting one or more failed attempts to unlock the barrier of the CTU 100;
detecting removal or disconnection of an attachment mechanism (e.g., a tow hitch) that connects the CTU 100 to the vehicle 104;
detecting removal of the CTU 100 from a specified location, such as the base of the CTU or other location;
detecting the connection of an unauthorized tow vehicle (e.g., assuming some known list of tow vehicles);
detecting removal or termination of a power supply to the CTU 100;
detecting occurrence of a sudden change in an internal condition of the CTU 100 (where the internal condition can include temperature, humidity, light, etc.), which can occur in response to someone cutting through the side of the CTU 100, for example (where a sudden change in the internal condition can refer to a change in the condition that exceeds a specified change rate);
detecting vibration similar to vibration caused by a drill, a hammer, or a saw attempting to break into the CTU 100;
detecting removal or disconnection of a tracking device that is part of the CTU 100, where the tracking device is used to track a current location of the CTU 100;
detecting that a duration of a stop of the CTU 100 exceeds a specified time duration;
detecting that the CTU 100 failed to stop at a pre-scheduled location along a route;
detecting that the CTU 100 has deviated from a predetermined route for greater than a specified threshold or longer than a specified time; or
another specified event.

Examples of the sensor 118 can include any or some combination of the following.
A barrier open/close sensor to detect opening of the barrier of the CTU 100.

For example, the barrier open/close sensor can include an accelerometer and/or a gyroscope. A barrier being opened may indicate a theft event.
A load sensor to detect a cargo load in the CTU 100, where the sensor can include a time-of-flight (ToF) sensor that can detect a distance between the ToF sensor and a surface inside the CTU 100, such as the surface of a cargo item, and where this distance provides an indication of the loading of the CTU 100 (e.g., percentage of loading of the CTU 100). Alternatively, the load sensor can include a camera that can capture an image of the inner chamber of the CTU 100 to allow for a determination of whether or not cargo has been removed. In further examples where cargo items are provided in individual compartments inside the CTU 100, load sensors can be provide in the individual compartments to detect whether or not each compartment is occupied by a cargo item. As another example, the load sensor can include an ultrasonic sensor, a LiDAR sensor, and so forth. Removal of cargo from the CTU 100 may indicate a theft event.
A tip sensor to detect tipping of the CTU 100, such as an accelerometer or a tilt meter. Tipping of the CTU 100 from a horizontal orientation (by greater than a specified angle with respect to horizontal) may indicate a theft event.
A unlock sensor that is connected to the lock mechanism of the barrier of the CTU 100, where the unlock sensor can detect an attempt to unlock the lock mechanism. The theft detector 109 can use the unlock sensor to detect the number of failed attempts to unlock the barrier, and if the number of failed attempts exceeds a specified threshold (one or more), then a theft event can be indicated.
A sensor connected to the attachment mechanism of the CTU 100, which is able to detect disconnection of the attachment mechanism from the vehicle 104. Disconnection of the attachment mechanism may be an indication of a theft event.
A sensor to detect that the CTU 100 has moved away from a specified location. For example, the sensor can include in short-range wireless communication transceiver (e.g., Bluetooth communication transceiver, a Wi-Fi communication transceiver, etc.). Removal of the CTU 100 from the location can cause the short-range wireless communication transceiver to lose communication with another entity, which indicates that the CTU 100 has been removed from the specified location. Alternatively, information from the position 119 can be used to detect removal of the CTU 100 from a specified location. Removal of the CTU 100 from the specified location may indicate a theft event.
A sensor to measure an internal condition of the CTU 100, including a temperature sensor, a humidity sensor, a light sensor, and so forth. If a detected temperature, pressure, and/or light deviates from a specified range or threshold, then a theft event may be indicated.
A vibration sensor to detect vibration of the CTU 100, such as vibration caused by a drill, hammer, or saw. Vibration of the CTU 100 for longer than a specified time duration may indicate a theft event.
A sensor that outputs an indication when a tracking device of the CTU 100 is disconnected or removed. Removal or disconnection of the tracking device may indicate a theft event.
A sensor to detect motion of the CTU 100. The motion can be based on the speedometer of the vehicle 104, and output of the accelerometer, and so forth. The detected motion of the motion sensor can be used to detect a duration of a stop exceeding a specified time threshold, or the failure to stop at a specified location along a route, either of which may indicate a theft event.
A sensor to detect removal or termination of power supply. For example, the sensor can include a voltage sensor or a current sensor that can detect that output power from the power supply is no longer available, which may indicate a theft event.

FIG. 1 further shows that the CTU 100 includes a communication transceiver 122. The communication transceiver 122 can be used to communicate over a network 116, which can be a wireless network or a wired network. Examples of a wireless network include a cellular network, a WLAN, and so forth. The communication transceiver 122 can communicate radio frequency (RF) signals over a wireless network, such as RF signals used in a cellular network or a WLAN.

An example cellular network can operate according to the Long-Term Evolution (LTE) standards as provided by the Third Generation Partnership Project (3GPP). The LTE standards are also referred to as the Evolved Universal Terrestrial Radio Access (E-UTRA) standards. In other examples, other types of cellular networks can be employed, such as second generation (2G) or third generation (3G) cellular networks, e.g., a Global System for Mobile (GSM) cellular network, an Enhanced Data rates for GSM Evolution (EDGE) cellular network, a Universal Terrestrial Radio Access Network (UTRAN), a Code Division Multiple Access (CDMA) 2000 cellular network, and so forth. In further examples, cellular networks can be fifth generation (5G) or beyond cellular networks. In additional examples, a wireless network can include a WLAN, which can operate according to the Institute of Electrical and Electronic Engineers (IEEE) 802.11 or Wi-Fi Alliance Specifications. In other examples, other types of wireless networks can be employed by the CTU controller 108 to communicate with a remote service, such as a Bluetooth link, a ZigBee network, and so forth. Additionally, some wireless networks can enable cellular IoT, such as wireless access networks according to LTE Advanced for Machine-Type Communication (LTE-MTC), narrowband IoT (NB-IoT), and so forth.

In some examples, in response to detecting a theft event, the theft detector 109 can send a notification through the communication transceiver 122 and over the network 116 to a remote target entity 124. The remote target entity 124 can be a server or a human administrator or emergency personnel.

As further shown in FIG. 1, the vehicle 104 includes a vehicle controller 120, which is able to control operations of the vehicle 104 (such as in examples where the vehicle 104 is an autonomous vehicle). In further examples, the vehicle controller 120 can be part of a vehicle 104 that is driven by a human driver, where the vehicle controller 120 controls various elements of the vehicle 104.

In some examples, the vehicle controller 120 can communicate with the CTU controller 108, over either a wireless link or a wired link. In response to detecting a theft event, the theft detector 109 can send a notification to the vehicle controller 120, which can cause the vehicle controller 120 to perform any of various different actions, such as sounding the horn of the vehicle, sounding an alarm of the vehicle 104, flashing the lights of the vehicle 104, applying brakes of the vehicle 104, providing a notification to a human driver in the vehicle 104, and so forth.

Although FIG. 1 shows the theft detector 109 being part of the CTU controller 108 of the CTU 100, it is noted that in other examples, the theft detector 109 can be part of the vehicle controller 120, or can be part of a remote system, such as a server implemented with one or multiple computers. In such examples, measurement data from the sensor 118 and the position sensor 119 can be provided to the theft detector 109 in the vehicle 104 or in the remote server.

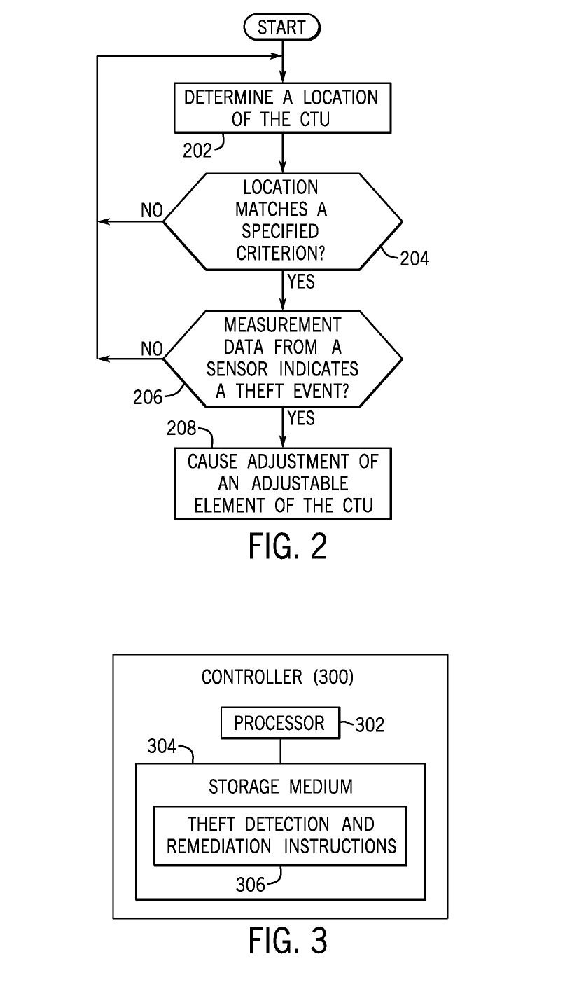

FIG. 2 is a flow diagram of a process that can be performed by the theft detector 109 according to some examples. The theft detector 109 determines (at 202) a location of the CTU 100, based on information from the position sensor 119. The theft detector 109 then determines (at 204) whether the location matches a specified criterion. The location of the CTU 100 matching the specified criterion can be used to trigger the theft detector 109 to perform theft event detection based on measurement data from the sensor 118.

In some examples, the location matching the specified criterion can include the location being within a specified geographic region, such as a region defined by a geofence. A geofence can define a specific geographic region, which can be a region that is associated with a specified characteristic. For example, the geofence can identify a geographic region that is an elevated crime region, based on statistics collected by law enforcement organizations, government agencies, insurance companies, cargo shippers, and/or other entities. If the CTU 100 has moved into this high crime region, then that is an example of the location matching the specified criterion. In further examples, the geofence can define another region that the CTU 100 should avoid.

Geofences are in many cases the initial trigger that causes the theft detector 109 to watch monitor the CTU 100 more frequently and to determine whether a sensor reading corresponds to a theft event. For example, when the CTU 100 enters certain geofences, the CTU controller 108 can adjust the behavior of the theft detector 109. In a more specific example, in a high crime geofence, the CTU controller 108 can report more often, and the theft detector 109 can correlate detected events with crime. In a low crime area, or in an area where the CTU 100 is expected to be located, the CTU controller 108 can report less often, and the theft detector 109 does not correlate events with crime as quickly. The geofence can adjust the correlation factors used for determining whether measured data represents a theft event. Similarly, a route and whether the CTU 100 deviates from the route can adjust correlation factors.

In other examples, the geofence can identify a region in which the CTU 100 should be located. For example, at a given time, the CTU 100 should be located at a shipping origin associated with a shipper. If the CTU 100 has exited this region at the given time, then the location of the CTU 100 is considered to match the specified criterion.

The specified geographic region of a geofence can be based on user-entered information or other information. The information can include crime statistics, for example. The theft detector 109 can access the information from a data source, which can be remote from the CTU 100 and accessible over the network 116.

In further examples, a location of the CTU 100 matching a specified criterion can include the location being across a territorial boundary, such as the boundary of a country, the boundary of a state, the boundary of a city, and so forth. When the CTU 100 crosses this territorial boundary, then that is an indication that the location matches the specified criterion. Once the CTU 100 crosses the territorial boundary, the theft detector 109 can be activated to detect a theft event.

As a further example, a location of the CTU 100 matching the specified criterion includes the location deviating from a specified route of the CTU 100. The CTU 100 may be expected to travel along the specified route from a shipping origin to a shipping destination, possibly with one or more intermediate cargo drop-off points along the specified route. If the CTU 100 deviates from the specified route by greater than a distance threshold or for longer than a time threshold, then that is an indication that the location of the CTU 100 matches the specified criterion, and thus theft event detection should be triggered.

As further shown in FIG. 2, if the location of the CTU 100 does not match the specified criterion, then the process of FIG. 2 returns. However, in response to the determined location matching the specified criterion, the theft detector determines (at 206) whether the measurement data from the sensor 118 indicates a theft event associated with the CTU 100. In response to the theft event, the CTU controller 108 causes (at 208) adjustment of an adjustable element of the CTU 100. If no theft event is detected, then the theft detector 109 returns.

FIG. 3 is a block diagram of a controller 300, which can be the CTU controller 108 (FIG. 1), the vehicle controller 120 (FIG. 1), or another controller. The controller 300 includes a processor 302 (or multiple processors). A processor can include a microprocessor, a core of a multi-core microprocessor, a microcontroller, a programmable integrated circuit, a programmable gate array, or another hardware processing circuit.

The controller 300 further includes a non-transitory machine-readable or computer-readable storage medium 304 storing machine-readable instructions that are executable on the processor 302 to perform specified tasks. Instructions executable on a processor can refer to instructions executable on a single processor or multiple processors.

The machine-readable instructions include theft detection and remediation instructions 306 that are executable on the processor 302 to perform the tasks discussed above, in some examples.

For example, the theft detection and remediation instructions 306 can determine whether a location of the CTU 100 matches a specified criterion. In response to determining that the location of the CTU matches the specified criterion, theft detection and remediation instructions 306 determine whether a physical characteristic of the CTU satisfies a triggering criterion, such as the physical characteristic represented by measurement data from the sensor 118 indicting a theft event.

Responsive to determining that the physical characteristic of the CTU satisfies the triggering criterion, the theft detection and remediation instructions 306 cause adjustment of an adjustable element (e.g., 102) of the CTU 100 (FIG. 1).

The storage medium 304 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A controller comprising:
at least one processor configured to:
determine a location of a cargo transportation unit (CTU);
responsive to the determined location matching a specified criterion, determine whether a sensor monitored event indicates a theft event associated with the CTU; and
in response to the theft event, cause adjustment of an adjustable element of the CTU.

2. The controller of claim 1, wherein the determined location matching the specified criterion comprises the determined location being within a specified geographic region.

3. The controller of claim 2, wherein the specified geographic region is an identified elevated crime region.

4. The controller of claim 2, wherein the at least one processor is configured to receive user-entered information regarding the specified geographic region.

5. The controller of claim 2, wherein the at least one processor is configured to determine the specified geographic region based on information from a remote system that maintains statistics on theft crimes in different geographic regions.

6. The controller of claim 1, wherein the determined location matching the specified criterion comprises the determined location being across a territorial boundary.

7. The controller of claim 1, wherein the determined location matching the specified criterion comprises the determined location deviating from a specified route of the CTU.

8. The controller of claim 1, wherein the sensor monitored event comprises one or more of a barrier of the CTU being opened, cargo in the CTU being removed, the CTU being tipped, a failed attempt to unlock the barrier of the CTU, removal or disconnection of an attachment mechanism that connects the CTU to a vehicle, removal of the CTU from a specified location, removal or termination of a power supply to the CTU, occurrence of a sudden change in an internal condition of the CTU, vibration of the CTU, removal or disconnection of a tracking device of the CTU, a duration of a stop of the CTU exceeding a specified time duration, the CTU failing to stop at a pre-scheduled location along a route, detecting connection of an unauthorized tow vehicle to the CTU, and detecting that the CTU has deviated from a predetermined route.

9. The controller of claim 1, wherein the at least one processor is configured to further:
in response to the theft event, send a notification to a vehicle controller that is part of a vehicle that is hauling the CTU, the notification to cause the vehicle to perform a specified action.

10. The controller of claim 1, wherein the adjustment of the adjustable element comprises one or more of changing a pressure of a tire of the CTU, locking a brake of the CTU, locking a cargo compartment of the CTU, sounding an alarm of the CTU, triggering transmission of a theft notification, flashing a light of the CTU, or disabling an attachment mechanism of the CTU.

11. A method comprising:
determining, by a controller, whether a location of a cargo transportation unit (CTU) matches a specified criterion;
in response to determining whether the location of the CTU matches the specified criterion, determining, by the controller, whether a physical characteristic of the CTU satisfies a triggering criterion; and
responsive to determining that the physical characteristic of the CTU satisfies the triggering criterion, causing adjustment, by the controller, of an adjustable element of the CTU.

12. The method of claim 11, wherein determining that the physical characteristic of the CTU satisfies the triggering criterion comprises detecting one or more of a barrier of the CTU being opened, cargo in the CTU being removed, the CTU being tipped, a failed attempt to unlock the barrier of the CTU, removal or disconnection of an attachment mechanism that connects the CTU to a vehicle, removal of the CTU from a specified location, removal or termination of a power supply to the CTU, occurrence of a sudden change in an internal condition of the CTU, vibration of the CTU, removal or disconnection of a tracking device of the CTU, a duration of a stop of the CTU exceeding a specified time duration, and the CTU failing to stop at a pre-scheduled location along a route.

13. The method of claim 11, wherein the determined location matching the specified criterion comprises the determined location being within a specified geographic region.

14. The method of claim 11, wherein the determined location matching the specified criterion comprises the determined location being outside a specified geographic region.

15. The method of claim 11, wherein the determined location matching the specified criterion comprises the determined location being across a territorial boundary.

16. The method of claim 11, wherein the determined location matching the specified criterion comprises the determined location deviating from a specified route of the CTU.

17. The method of claim 11, wherein the adjustment of the adjustable element comprises an evasive action to deter movement of the CTU.

18. A non-transitory machine-readable storage medium storing instructions that upon execution cause a controller to:
determine a location of a cargo transportation unit (CTU);
responsive to the determined location matching a specified criterion, determine whether a sensor monitored event indicates a theft event associated with the CTU; and
in response to the theft event, cause adjustment of an adjustable mechanical element of the CTU.

19. The non-transitory machine-readable storage medium of claim 18, wherein the sensor monitored event comprises an event corresponding to measurement data from a sensor of the CTU.

20. The non-transitory machine-readable storage medium of claim 18, wherein the sensor is selected from among a barrier open/close sensor to detect opening of a barrier of the CTU, a load sensor to detect a cargo load in the CTU, a tip sensor to detect tipping of the CTU, an unlock sensor to detect an attempt to unlock a lock mechanism of the CTU, a sensor to detect disconnection of an attachment mechanism attaching the CTU to a vehicle, a sensor to measure an internal condition of the CTU, a vibration sensor to detect vibration of the CTU, a sensor that detects disconnection or removal of a tracking device of the CTU, a sensor to detect motion of the CTU, and a sensor to detect removal or termination of power supply.
